(19) United States
(12) Patent Application Publication
(10) Pub. No.: US 2024/0082976 A1
(43) Pub. Date: Mar. 14, 2024

(54) APPARATUS FOR MEASURING A TOOL OR A COMPLETE TOOL, TOOL, PROCESSING CENTER AND METHOD FOR COMPILING A DIGITAL IMAGE OF A TOOL OR A COMPLETE TOOL

(71) Applicant: Franz Haimer Maschinenbau KG, Hollenbach-Igenhausen (DE)

(72) Inventors: Andreas Haimer, Hollenbach-Igenhausen (DE); Kai Duhme, Bielefeld (DE)

(21) Appl. No.: 18/464,402

(22) Filed: Sep. 11, 2023

(30) Foreign Application Priority Data
Sep. 9, 2022 (DE) 10 2022 123 017.1

(51) Int. Cl. B23Q 17/24; B23Q 17/22; G01B 11/00; G01B 11/24

(52) U.S. Cl. CPC B23Q 17/2457; B23Q 17/2208; G01B 11/005; G01B 11/2408

(57) ABSTRACT

An apparatus is provided for measuring a tool or a cutting tool, or a complete tool including a tool holder and a tool or a cutting tool, clamped in the tool holder. A method is provided for compiling a digital image of a tool or a cutting tool, or a complete tool including a tool holder and a tool or a cutting tool, clamped in the tool holder, in particular by using the apparatus. During the method, the tool or the complete tool is sampled for the compilation of the digital image. At least one first cutting point, for example a cutting start point, and a second cutting point, for example a cutting end point, are measured for the tool or the complete tool. A cutting region is then ascertained in the digital image by using the first and second cutting points forming a collision-relevant digital twin.

### CROSS-REFERENCE TO RELATED APPLICATION

This application claims the priority, under 35 U.S.C. § 119, of German Patent Application DE 10 2022 123 017.1, filed Sep. 9, 2022; the prior application is herewith incorporated by reference in its entirety.

### FIELD AND BACKGROUND OF THE INVENTION

The invention relates to an apparatus for measuring a tool, in particular a cutting tool, or a complete tool including a tool holder and a tool, in particular a cutting tool, clamped in the tool holder, and to a method for compiling a digital image of a tool, in particular a cutting tool, or a complete tool including a tool holder and a tool, in particular a cutting tool, clamped in the tool holder, in particular by using such an apparatus.

It is conventional to measure a complete tool including a tool holder and a tool, for example a cutting tool, clamped, for example compressed, in the tool holder, before coupling to a machine tool, for example configured as a CNC processing machine, by using an apparatus for measuring a tool, also referred to in brief below as a “presetting instrument” (“presetting”, “presetting data”).

The dimensions of the tool or of the complete tool, which are ascertained in this way by the presetting instrument, are then available to the machine tool, or used therein, for optimization of the workpiece processing in the machine tool.

In particular, the presetting ensures that workpiece-processing parts of the tool, for example a cutting edge of a cutting tool, have the position dimensions acceptable for the planned processing of the workpiece on the machine tool.

Through the use of such a presetting instrument, in this case in particular the length of the complete tool, the diameter and/or the cutting shape of the clamped tool or cutting tool—and if appropriate various further proportions of or for the tool or complete tool, are measured.

If these data are directly relevant for the quality of the workpiece processing of the workpiece in the machine tool, the tool measuring in the presetting instrument must take place with high accuracy.

Such a measuring device, or such a presetting instrument, is for example known from the presetting instrument of the type range “UNO” or the type range “VIO” from the firm Haimer.

Moreover, it is also known to ascertain a so-called digital twin, or in simple terms a digital image, of the tool or complete tool also from data ascertained in the presetting instrument, in order to use this digital twin for preventive collision protection in the machine tool.

In the scope of this preventive collision protection, in particular an entire processing operation of the machine tool—with a coupled complete tool—is at least computationally simulated and checked for whether collisions occur (collision observation, collision simulation) between the tool or the complete tool and the workpiece or the surrounding parts (machine table, clamping apparatus, etc.).

In this case, it is also known that the very high accuracy needed for the tool presetting is not necessary for the digital twin used for the collision protection, or for the collision simulation.

Ascertainment of a digital twin of a tool or complete tool is described, for example, in European Patent Application EP 3 664 961 A1, corresponding to U.S. Pat. No. 11,612,973 B2.

### SUMMARY OF THE INVENTION

It is accordingly an object of the invention to provide an apparatus for measuring a tool or a complete tool, a tool, a processing center and a method for compiling a digital image of a tool or a complete tool, which overcome the hereinafore-mentioned disadvantages of the heretofore-known apparatuses and methods of this general type, which improve the presetting instruments known in the prior art, and which, in particular, improve and/or simplify collision checking by using digital images of tools or complete tools.

With the foregoing and other objects in view there is provided, in accordance with the invention, an apparatus for measuring a tool or a complete tool including a tool holder and a tool clamped in the tool holder, a tool, a processing center, as well as a method for compiling a digital image of a tool or a complete tool including a tool holder and a tool clamped in the tool holder, having the features of the respective independent claim.

Advantageous developments of the invention are the subject of dependent claims and the following description, and relate both to the apparatus according to the invention and to the method according to the invention.

Terms such as up, down, front, back, left or right, which may be used, are—unless otherwise explicitly defined—to be understood according to conventional understanding—as well as in the light of the appended figures. Terms such as radial and axial are, if used and not otherwise explicitly defined, to be understood in relation to mid-axes or symmetry axes of components/component parts described herein—as well as in the light of the appended figures.

The term “substantially”—if used—may (according to the interpretation of the Supreme Court) be understood in that it is a matter of “an extent which is still significant in practice”. This terminology thus implies that possible deviations from exactitude may occur without intent (that is to say without a functional reason) because of manufacturing or mounting tolerances or the like.

In the method for compiling a digital image of a tool or a complete tool including a tool holder and a tool clamped in the tool holder, for the compilation of the digital image, the tool or the complete tool is sampled.

In addition to the sampling of the tool or of the complete tool at least one first cutting point, in particular the first cutting point, for example a cutting start point, and a second cutting point, for example a cutting end point, are measured for the tool or the complete tool.

Optionally, a plurality of cutting points or cutting regions (in the case of more complex tools) may also be measured or displayed, which may be expedient particularly when there are a plurality of cutting regions—for example at different heights—and/or turning or cutting locations.

The measuring of one cutting point, i.e. only the first cutting point, may in particular already be sufficient if prior knowledge relating to a geometry of a cut is available, for example by knowing that the cut extends from a first cutting point or the first cutting point as far as an end of the tool.

The measuring of the at least first cutting point, or of the first and the second cutting point, may—by using a measuring unit—take place in an automated fashion, for example by use of image processing, feelers, lasers or other measuring devices integrated in or cooperating with the measuring unit, and/or with artificial intelligence which is optimized with the aid of a self-learning algorithm, or manually, for example by an operator determining corresponding points in a metrology program relating thereto.

Measuring may also include already measured cutting points then being used in the method. Furthermore, measuring may also mean that points in graphical data sets obtained by measuring are purposely selected and established as cutting points.

For the measuring, it may also be expedient for prior knowledge to be made available, in particular or for example in the form of suggestions, for the at least first cutting point or first and second cutting point to be measured, for example by corresponding data or data sets and/or from a database or a programming system which is then optionally adjusted or adapted and/or aligned with the aid of a setpoint/actual value comparison by the measuring.

In the measuring according to the invention, for example, points—thus proposed by using such prior knowledge—may thus automatically be approached (and then measured).

Especially in the case of complex tools, this may be particularly advantageous when cutting regions at different heights and/or rotation angle locations (in such a complex tool) are thereby approached.

Expressed another way, or more generally, prior knowledge, in particular tool data relating to cutting points or the cutting region of a tool, for example made available from existing data, for example manufacturer's data, or normalized data, may be used in order to establish and/or to check and/or optionally adapt the measured cutting point or points.

In the digital image, a cutting region is then ascertained by using at least the first cutting point, in particular the first and the second cutting point (“collision-relevant digital twin” (in the case of machining tools, also “machining-relevant digital twin”)).

For—complex—tools, which may have a plurality of cutting regions, at least one first cutting point, in particular a first and a second cutting point, are measured separately for each cutting region and the respective cutting region is ascertained therefrom.

The invention may therefore rapidly arrive at the collision-relevant twin in the fastest possible way from the general digital twin—and moreover ascertain a machining-relevant twin that may be used immediately in a programming system.

In particular, the additional measuring—and use of a measurement —moreover has the advantage, for example over pure (automatic/automated) image evaluation in a digital image, that an uncertainty of an automatic image evaluation, or the logic thereof, is avoided by the additional measuring. The accuracy and/or reliability in the ascertained cutting region is thereby higher.

In one modification, provision may also be made that by the sampling, or during the sampling, at least the first cutting point or the first and the second cutting point, or the cutting points, are already ascertained, for example in an automated fashion from the sampling points or from the digital image. In this case, the measuring of the cutting point or cutting points—as an additional step—may be obviated.

“Digital image” may signify a two-dimensional or three-dimensional image, for example a contour profile or an envelope contour.

Sampled may in this case signify in particular that, for example by using an in particular optical measuring or metrology unit/device, such as are used for example in presetting instruments, images of different regions of an object are acquired, in this case of the tool or of the complete tool, for example in a transmitted-light method—and are evaluated to generate the digital image and/or collision-relevant twin.

The sampling—depending on the way in which it is carried out—may lead to a two-dimensional or even three-dimensional digital image, for example to a three-dimensional image by the object being rotated during the sampling.

Alternatively, a three-dimensional image may also be generated, or calculated, mathematically from a two-dimensional image. For example, the aforementioned rotation of the object may be mathematically “simulated” so as to make a three-dimensional image from the two-dimensional image.

“Different regions” may signify the tool at different heights and/or the tool in different rotated views.

In particular, a contour or a contour profile or an envelope contour of an object, such as the tool or complete tool in this case, may be ascertained by such sampling.

A “contour” or a “contour profile” is intended in particular to be understood as a maximum extent of any cross-sectional area along a rotation axis of the tool, or of the complete tool. The contour or the contour profile is, in particular, suitable to be able to calculate collisions with a workpiece in a processing process in advance (collision simulation/observation). The same correspondingly applies to the envelope contour, which can be understood as a three-dimensional contour or contour profile.

In this case, the invention is based on the discovery that cutting regions of the tool or cutting tool, which are usable for any collision observation, must be identified and distinguished from the entire contour. This is because the cutting regions of the tool must be able to enter the workpiece to be processed without there being a collision. On the other hand, the cutting regions must be taken into account for a collision observation in relation to machine elements, for example a chuck for clamping the workpiece.

To this extent, the invention distinguishes between the “normal” digital twin and a collision-relevant or machining-relevant digital twin.

In this case, the “machining-relevant twin” may then be understood as one which, besides the information items assigned to the collision-relevant twin, has further information items and/or these original information items in a particular structure or processing, for example a layer structure, and/or by marking, in particular color marking, preferentially also conformally or compatibly with CAD/CAM systems and/or processing systems.

Accordingly, the invention determines this cutting region to be differentiated during the collision observation in a simplified way, but nevertheless with sufficient accuracy, by measuring at least one first cutting point, or optionally a first and a second cutting point, such as a cutting start point and a cutting end point, for the tool or the complete tool.

Measuring may in this context also mean that data can be generated in this case with high accuracy, and measuring may be made available (for example by corresponding high-resolution metrological systems) with a higher accuracy—than other forms of ascertainment or establishment.

In contrast to the prior art, this is not done theoretically in a CAD/CAM programming environment which is removed from the real manufacturing environment, and in which different models are merely combined, but in practice on the actual tool or complete tool (after mounting)—expediently—directly in the manufacturing or tool presetting.

In this way, interface problems, defective and incomplete data sets and/or tool drawings or models and/or defective feedback loops to the actual tool are avoided.

Furthermore, by or in the manual determination or measuring—in the department—intrinsic empirical values such as length tolerances after the regrinding, neck clearances and/or shaving recesses may be taken into account.

At least the first, optionally the first and the second, cutting point or cutting start point and cutting end point, may then define the cutting region—and then be taken into account in the digital image of the tool or complete tool (collision-relevant or machining-relevant digital twin).

Furthermore, the invention offers the advantage that the method forms an integrated process, or an integrated (total) method, which can moreover be incorporated or integrated into a total flow of an (existing) process, for example into the tool measuring in a presetting instrument, and in particular can be integrated into a measuring unit or metrology system therein.

Where previously, for a digital image of a tool or complete tool, data may have needed to be combined from various data sources (from different processes), for example (CAD/CAM) data of tools, (CAD/CAM) data of tool holders—and possibly in turn separate (CAD/CAM) data of cutting and the like, to form a common (total) data structure (cf. layer structure according to DIN) (that is to say expressed illustratively so that the digital image has had to be “assembled” from data of such various data sources), so that interface problems have been virtually unavoidable, in particular due for example to incompatible or nonconformal reference points, and feedback chains which are difficult because they are repeated, the invention—as an integratable or integrated method representing a total flow—makes it possible for (integrated, compatible) data to be generated from one data source and used for the collision-relevant digital twin.

Data conformity and data compatibility as well as data generated and available in one “place” or from one source, which correspond to the genuine actual values, thus ensure high efficiency and effectiveness, simplicity and low error susceptibility in the invention, or in the method.

Expressed briefly and simply, interface problems and data conformity problems, or in general problems with data integration, can be avoided by the invention.

Thus, in particular, if the method is integrated into tool measuring (of a presetting instrument) where the usual presetting data are also generated or measured besides the digital image or the collision-relevant digital twin according to the invention, by combining the two data sets of conformal data coming from one data source, an integrated, comprehensively functional data set may be made available (for the presetting and the collision observation), for example to the machine tool or a programming station, particularly in a (digital) data format.

In this case, it is expedient in particular to make the digital image and/or the collision-relevant digital twin available in the form of data or in the form of a data set in a digital data format, for example in a data format VDA-FS, IFC, IGES, STEP (ISO Standard 10303), STL or DXF.

It may furthermore be expedient to generate an image file, for example in the data format JPEG, Windows Bitmap or Graphics Interchange Format, which shows the entire and/or one or more sections of the tool or complete tool and/or of the digital image and/or of the collision-relevant digital twin.

Further, it is also expedient to provide an interface in order to transmit data or data sets—generated during the method—by using a data connection and/or write them onto a storage medium.

A “storage medium” is intended in particular to be understood as data carriers used in data processing, for example flash memories, USB memories, floppy disks or hard drives. A “data connection” is intended in particular to be understood as a wired and/or wireless data connection, in particular a radio data connection.

Through the data connection, data or data sets may be transmitted to an apparatus or instrument, for example a machine tool, in particular by using a protocol.

Furthermore, the method also offers the advantage that, as has been discovered, the very high accuracy needed for the tool presetting is not necessary for the digital twin used for the collision protection, or for the collision simulation.

Thus, it is advantageous to carry out the sampling of the tool or of the complete tool—“only” discretely—at various (predeterminable) tool or complete tool heights (and optionally in various turning positions there)—and to ascertain the digital image therefrom.

By suitable mathematical methods, for example by interpolation between the ascertained, and thus numerically limitable sampling data, a 2D model and/or a 3D model (or 2D and/or 3D contour model) of the tool or of the complete tool may then be calculated from the sampling data as a digital image of the tool or complete tool.

In the digital image—for the collision-relevant twin—the “collision nonrelevant” cutting region is then defined.

If a low accuracy requirement is placed on the digital twin used for the collision protection, or for the collision simulation, i.e. in this case the collision-relevant digital twin, by specifying an expediently limited number of sampling heights the data volume ascertained may be limited, computing time and memory space may be saved and the collision simulation may be carried out —without loss of reliability.

It is furthermore expedient that during the determination of the cutting region by using at least the first cutting point, optionally the first and second cutting point, a point lying closest or points lying closest to this point or these points is or are determined in the digital image of the tool or of the complete tool, and the cutting region is defined or ascertained, in particular markable in the digital image, by using this closest lying point/these closest lying points.

Expressed simply, by using the “remeasured” cutting point or the “remeasured” cutting points, the corresponding point or the corresponding points is or are searched for in the digital image, for example by using “least distances”, so that the “image point or points” found in this way may thus—as a point or as points of the digital image—define the cutting region in the digital image.

In this case, it is also found advantageous that a great accuracy does not need to be placed on the remeasurement of the at least one cutting point, or optionally the two cutting points, since on the one hand the digital image or the collision-relevant digital twin is subject to rather less accuracy requirements, and on the other hand the image point or points are ascertained only from the measured cutting point or the measured cutting points.

Furthermore, provision may also be made that a scan, for example a 2D or 3D scan, of the tool or of the complete tool is carried out during the sampling.

It may also be expedient to carry out the scanning or sampling by using different metrology systems, for example laser-assisted or ultrasound-assisted systems, or optical and/or tactile systems and the like.

During the 2D scan, it is expedient to measure a bilateral contour of the tool or of the complete tool in a predetermined fixed position of the tool or complete tool, so that during the measuring the tool or the complete tool remains unrotated—and a 2D contour can thus be ascertained.

In this case, provision may in particular be made in this case that during the sampling, a 2D scan of the tool or of the complete tool is carried out when the tool is a nonrotating tool, for example a lathe chisel.

Provision may also be made that, during the sampling, a 3D scan of the tool or of the complete tool is carried out.

During the 3D scan, it is expedient for a unilateral contour of the tool or of the complete tool to be measured, the tool or the complete tool being rotated during the measuring—so that an envelope contour can be ascertained.

In this case, in particular, provision may be made in this case that during the sampling, a 3D scan of the tool or of the complete tool is carried out when the tool is a rotating tool, for example a milling tool.

A rotating tool may in this case signify that such a tool is rotated during the processing of a workpiece; a nonrotating tool may mean that such a tool is not rotated during the processing of a workpiece.

“Unilateral” or “bilateral” may signify that the contour is determined only on one side (possibly as far as a mid-axis, symmetry axis) or on both sides on the two-dimensionally imaged tool or complete tool.

Sampling according to the invention—for the compilation of the digital twin—may also take place by a stitching method (concatenation of images).

In this case, individual images of the tool or of the complete tool or of parts of the tool or of the complete tool may—optionally with high resolution—be generated (that is to say, in this case only a relevant region such as an edge is stitched), and these are combined to form an overall image of the tool or of the overall tool (“stitching”) (while in the case of scanning, rows are placed next to one another). Such an overall image may be the digital twin or may be used to compile the digital twin.

The stitching may, for example, take place in a transmitted-light method, as well as in a reflected-light method and/or other image processing methods. By the reflected-light method, measurements which cannot be made available by the transmitted-light method are possible, for example in respect of surfaces/surface structures.

During such stitching, coordinates of the individual images may also be fixed—so as to ascertain positions and/or coordinates of image points with the aid of the overall image. Expressed in another way, or illustratively, this “readout” of image points from the overall image may also be regarded as a measuring of points—and may thus also be applied to cutting points. In general, it is thus also possible to determine or measure visible elements on the overall image retrospectively.

It may also be expedient if, for the compilation of the digital image of the complete tool, only the sampling of the tool is carried out for the complete tool if and when data for the digital image of the tool holder are available in another way, in particular have already been stored and/or are read in.

Expressed another way, the sampling may optionally be restricted only to “missing” regions of the tool or complete tool if there is prior knowledge in this regard, for example from the manufacturer, and/or standardizations and standards (DIN/ISO), for example relating to the tool holder and/or the tool interface and/or geometrical information items in this regard, such as lengths and/or diameters and the like, are made available (and possibly read in via (defined) interfaces).

Sampling and prior knowledge may thus be combined for or in the digital image, which saves on process time and/or process capacity. In this way, a situation which has a detrimental effect on the sampling, for example contamination or the like on the tool or complete tool, may also be excluded.

Furthermore, it is also expedient for at least one data set, in particular a plurality of data sets, to be generated during the compilation of the digital image of the tool or of the complete tool, in particular a data set having data of the digital image and having data for the ascertained cutting region and/or a data set having data of the digital image and having data for the ascertained cutting region as well as having measuring data of the tool, in particular from measuring by using an apparatus according to the invention for measuring a tool or a complete tool.

It is particularly expedient for the tool or the complete tool to be measured, in particular by using an apparatus according to the invention for measuring a tool or a complete tool.

That is to say, provision is made in this case for the tool or the complete tool also to be measured—as usual, in particular by using an apparatus according to the invention.

As a development, provision may then also be made for a collision check to be carried out by using the digital image ascertained according to the invention or the collision-relevant digital twin.

It is particularly expedient that, for example, by marking the (cutting) start and/or endpoints together with measuring the cutting region, a file having color labelling and/or a layer structure required according to ISO is compiled, so that use in conventional programming systems may be carried out in an automated fashion and (in the ideal case) without additional reprocessing (machining-relevant digital twin).

Expressed another way, or more simply and in general, cutting information determined according to the invention may also be made available in other ways or to other systems, such as processing and/or programming systems (for example CAD/CAM systems), for example in layers and/or layer structures or other digital markings.

It also seems expedient in general for data generated according to the invention to be made available in normalized or standardized form, for example in a layer structure, for other systems (for example CAD/CAM systems), for example and expediently by using DXF and/or step files.

It may also be particularly expedient for data (or data sets) generated according to the invention for a tool or complete tool to be assigned an identification, for example in the form of an ID number, which is then specific to the tool or complete tool handled according to the invention. Data specified in this way—for a tool or complete tool—may then be used further in processing programs, (inventory) management systems and the like.

Furthermore, it may also be expedient for a method according to the invention to be carried out with a cutting tool and/or with a cutting tool compressed in the tool holder.

The apparatus for measuring a tool or a complete tool including a tool holder and a tool clamped in the tool holder provides a measuring unit and a calculation and control unit.

This measuring unit and the calculation and control unit are adapted in such a way that, for the compilation of a digital image of the tool or of the complete tool, the tool or the complete tool is sampled, in addition to the sampling of the tool or of the complete tool at least one first cutting point, in particular the first cutting point, for example a cutting start point, and a second cutting point, for example a cutting end point, are measured for the tool or the complete tool, and a cutting region is marked in the digital image by using at least the first cutting point, in particular the first and the second cutting point.

In particular, the measuring unit and/or the calculation and control unit is thus adapted to carry out one of the above-described methods according to the invention or method steps according to the invention.

In this case, a “ . . . unit”, such as the measuring unit and the calculation and control unit, may in particular also have a processor, a memory unit, an interface and/or an operating, control and calculation program, in particular stored in the memory unit.

Expressed simply and illustratively, it is particularly expedient to carry out methods according to the invention and/or also method steps according to the invention, such as the sampling and/or the “remeasuring” of the cutting point or of the cutting points, by using an apparatus according to the invention.

It is found particularly expedient in this case for conventional presetting instruments previously known per se to be supplemented with the functionalities according to the invention (of the apparatus and/or method).

It is in this case found particularly advantageous that previously conventional presetting instruments may remain almost unchanged in terms of hardware and/or control, on the basis of which the supplement according to the invention only extends to the software. New or adapted program modules may ensure this.

Optionally—for carrying out—one of the above-described methods according to the invention or method steps according to the invention, the measuring unit and/or the apparatus according to the invention may have a control unit which ensures corresponding driving of the measuring unit in order to carry out one of the above-described methods according to the invention or method steps according to the invention.

A (tool) presetting instrument provides an above-described apparatus according to the invention for measuring a tool or a complete tool.

A processing center provides an above-described apparatus according to the invention for measuring a tool or a complete tool, in particular a (tool) presetting instrument according to the invention, as well as a machine tool.

It is in this case expedient in particular for the apparatus and the machine tool to be mounted on a common base and/or for the apparatus to be integrated into the machine tool (functionally and/or as a component) into the machine tool.

The description provided so far of advantageous configurations of the invention contains numerous features which are sometimes reproduced as being multiply combined in the individual dependent claims. These features may, however, also expediently be considered individually and combined to form suitable further combinations—including between the arrangements/apparatuses and methods.

Even though some terms in the description or in the patent claims are used in the singular or in combination with a numeral, the scope of the invention is not meant to be restricted to the singular or the respective numeral for these terms. Furthermore, the words “a” or “an” are to be understood not as numerals but as indefinite articles.

The above-described properties, features and advantages of the invention, as well as the way in which they are achieved, will be more clearly and plainly understandable in conjunction with the following description of the exemplary embodiments of the invention, which will be explained in more detail in conjunction with the drawings/figures (the same components/component parts and functions have identical reference signs in the drawings/figures).

The exemplary embodiments serve to explain the invention and restrict the invention neither to the combinations of features specified therein nor in relation to functional features. Furthermore, suitable features of any exemplary embodiment may also be explicitly considered in isolation, separated from an exemplary embodiment, introduced into another exemplary embodiment in order to supplement the latter and/or combined with any of the claims.

Although the invention is illustrated and described herein as embodied in an apparatus for measuring a tool or a complete tool, a tool, a processing center and a method for compiling a digital image of a tool or a complete tool, the construction and method of operation of the invention, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view illustrating a process for processing a workpiece by using a presetting instrument according to an embodiment of the invention;

FIG. 2 is an enlarged, perspective view of the presetting instrument of FIG. 1;

FIG. 3 is a screenshot illustrating the sampling of a complete tool, in this case a turning tool clamped in a tool holder, during a 2D scan according to an embodiment of the invention;

FIG. 4 is a screenshot illustrating the measuring of a first cutting point of a tool, in this case a turning tool clamped in a tool holder, according to an embodiment of the invention;

FIG. 5 is a screenshot illustrating the measuring of a second cutting point of a tool, in this case a turning tool clamped in a tool holder, according to an embodiment of the invention;

FIG. 6 is a screenshot illustrating the sampling of a complete tool, in this case a milling tool clamped in a tool holder, during a 3D scan according to an embodiment of the invention;

FIG. 7 is a screenshot illustrating the measuring of a first cutting point of a tool, in this case a milling tool clamped in a tool holder, according to an embodiment of the invention;

FIG. 8 is a screenshot illustrating the measuring of a second cutting point of a tool, in this case a milling tool clamped in a tool holder, according to an embodiment of the invention;

FIG. 9 is a perspective view of a collision-relevant digital twin according to an embodiment of the invention; and

FIGS. 10a and 10b respectively show an image stitched in the transmitted-light method of a tool according to an embodiment of the invention, and an image stitched in the reflected-light method of a tool according to an embodiment of the invention.

### DETAILED DESCRIPTION OF THE INVENTION

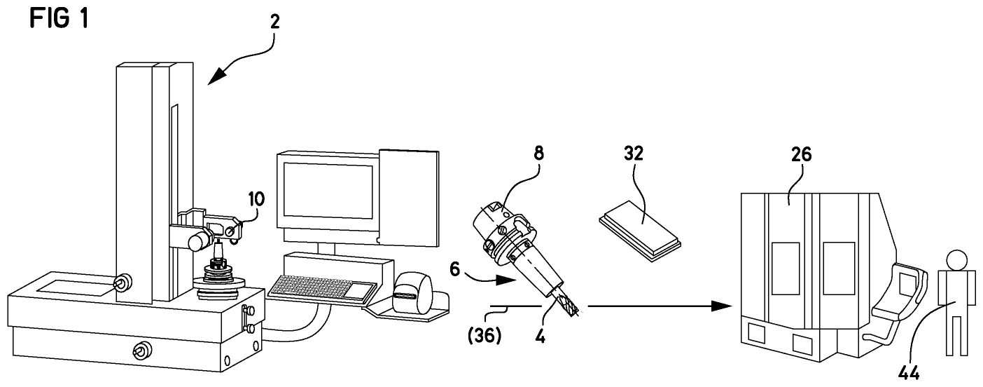

Diagram “Processinq of a Workpiece” (FIG. 1):

Referring now to the figures of the drawings in detail and first, particularly, to FIG. 1 thereof, there is seen an illustration of the processing of a workpiece 32 by a machine tool 26, in this case the milling processing of a workpiece 32 to be milled by a CNC machine tool/processing machine 26.

As shown by FIG. 1, the processing includes the CNC machine tool 26, on which the workpiece 32 is processed or milled—by using a (milling) tool 4 clamped in a tool holder 8, in this case a (hydraulic-expansion) chuck 8 (referred to overall as a complete tool 6).

Before the workpiece 32 is processed, a simulated collision check for the processing is carried out for or on the machine tool 26.

As an alternative to carrying out the collision check on the machine tool, this check may likewise also be carried out on a separate programming workstation.

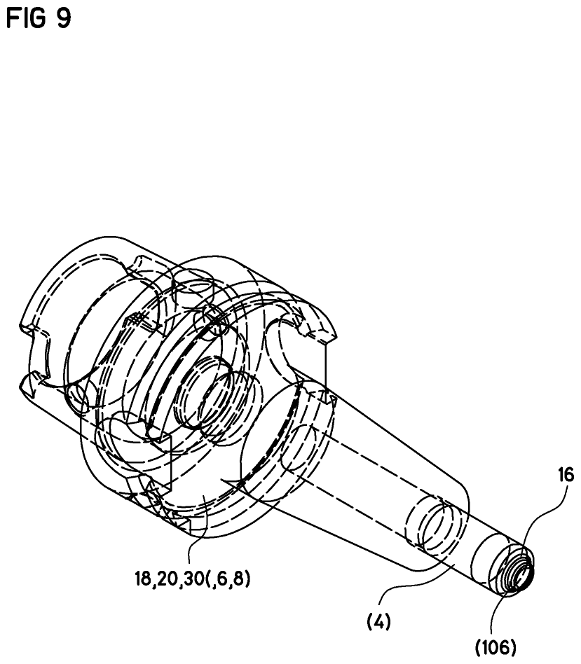

For this purpose, as also shown by FIG. 1, a presetting instrument 2 is provided, which generates the data (presetting data)—needed for the presetting—as well as the data (collision-relevant digital twin 20—cf. FIG. 9)—needed for the collision check, which—as illustrated by an arrow in FIG. 1—are transmitted (from the presetting instrument 2) in the form of a plurality of data sets to the machine tool 26.

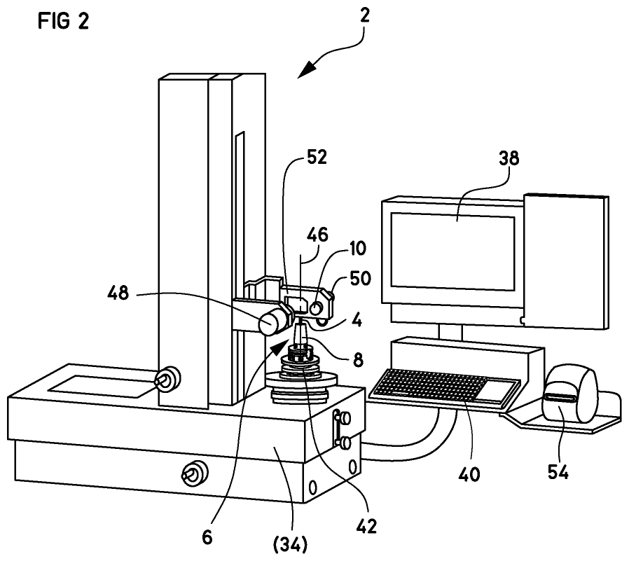

Presetting Instrument 2 (FIG. 2):

FIG. 2 illustrates in detail the tool presetting instrument, abbreviated to presetting instrument 2—for measuring a tool 4 or complete tool 6.

The presetting instrument 2 has an optical measurement apparatus 10 in the form of a camera apparatus 10, through the use of which information items may be acquired from the tool 4 or complete tool 6.

The presetting instrument 2 furthermore has a calculation and control unit 34, which includes inter alia a processor, a memory unit, an interface to the camera apparatus, an interface 36 to the machine tool, and calculation and operating programs stored in the memory unit, executable by the calculation and control unit 34 and “operable” by using a display device 38 and input device 40, for instance the measuring of a tool 4 and the generating of the data for a collision-relevant digital twin 20 of a tool 4 or complete tool 6.

The calculation and control unit 34 is thus intended—by using corresponding calculation and operating programs—to cause to be executed or to carry out conventional measuring of a tool 4 or of a complete tool 6—by using the camera apparatus 10, presetting data being generated by the tool 4 or the complete tool 6.

Furthermore, the calculation and control unit 34 makes it possible —likewise by using corresponding calculation and operating programs and by using the camera apparatus 10—to generate data of the tool 4 or of the complete tool 6 for the collision check, namely the collision-relevant digital twin 20.

The presetting data and/or the collision-relevant digital twin 20 may—in the form of one or more data sets—be provided in digital form for further machine processing, for example in the data formats VDA-FS, IFC, IGES, STEP, STL and DXF.

In the present case, separate data sets of presetting data and the collision-relevant digital twin 20 are provided, as well as a common data set including both sets of data.

Through the interface 36 to the machine tool 26, the data or data sets may be transmitted/communicated to the machine tool 26 (where the simulated collision check can be carried out or is carried out by using the data).

The presetting instrument 2 furthermore has, as shown by FIG. 2, the display device 38 in the form of a monitor 38 and the input device 40, which is configured as a keyboard 40. Alternatively, the input device 40 may also be configured as a touchscreen-functional monitor 38.

An operator can operate the calculation and operating programs via the keyboard 40, with functionalities, data and status displays of the calculation and operating programs being displayed on the monitor 38, and initiate forwarding of the data or the data sets to the machine tool 26—via the interface 36.

As also shown by FIG. 2, the complete tool 6 is disposed on a spindle 42 which—while being driveable manually by an operator 44 and also by an actuator (not represented in detail)—is mounted rotatably about a rotation axis 46. The actuator can be driven manually by the operator 44—and also in an automated fashion by the calculation and control unit.

The aforementioned camera apparatus 10 of the presetting instrument 2 is configured as a transmitted-light system. In this case, a camera 48 and an illumination device 50 lie on opposite sides of a complete tool 6 disposed on the spindle 42. The camera apparatus 10 is mounted on a carriage 52—and is displaceable along two axes.

An interface for a printer 54 is furthermore available.

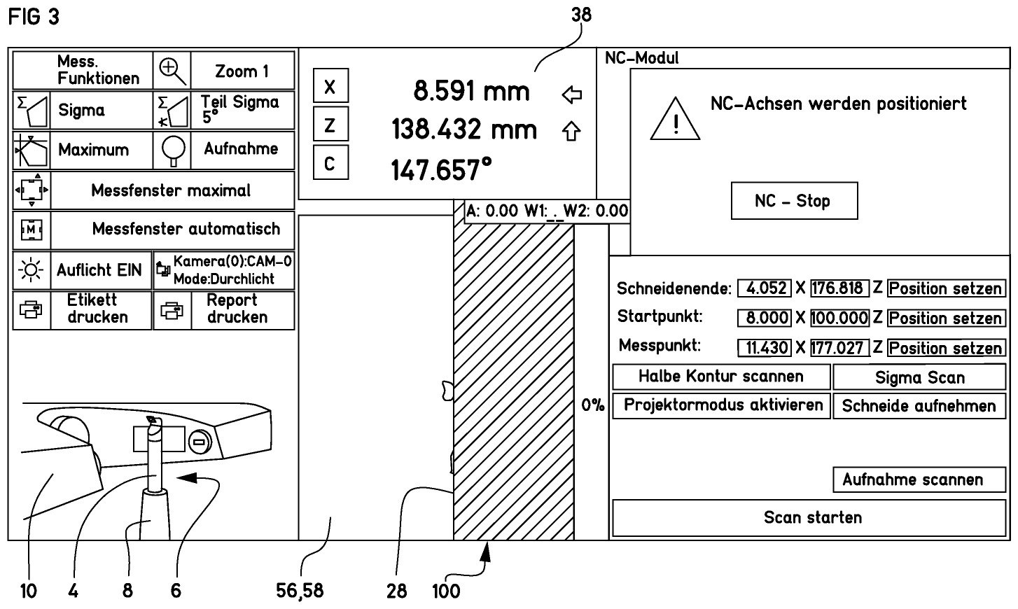

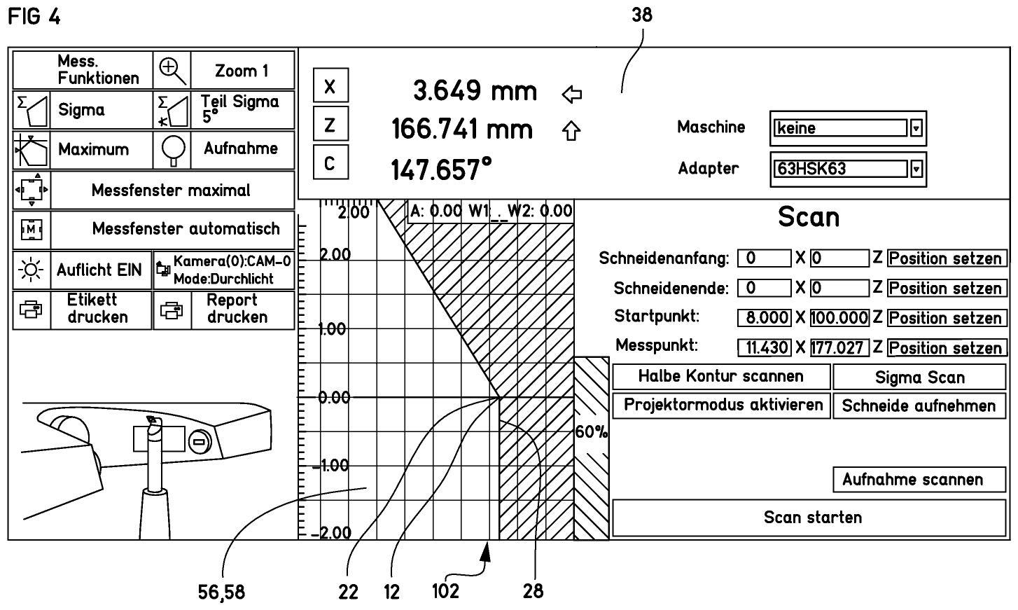

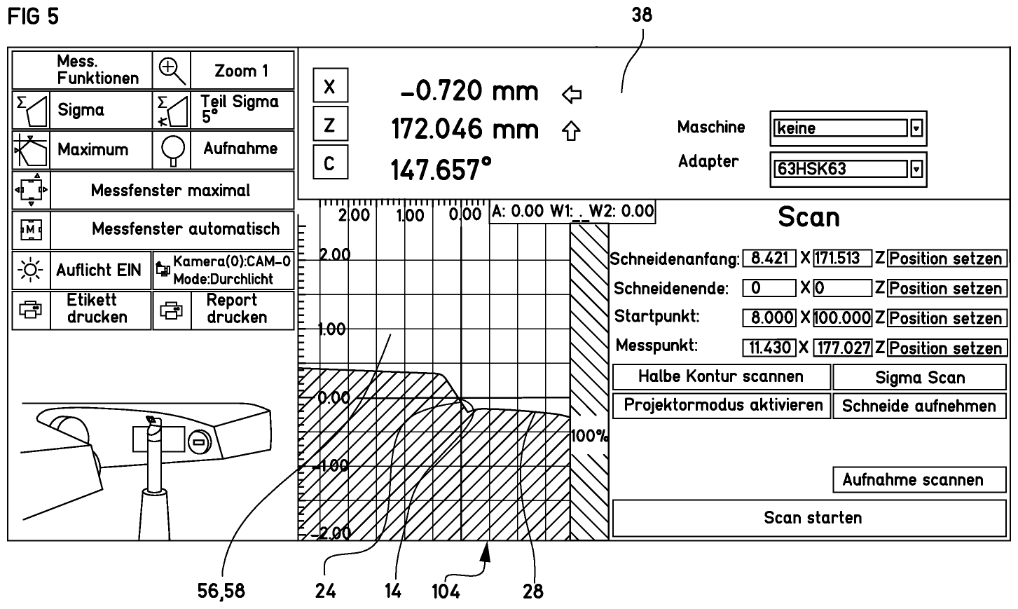

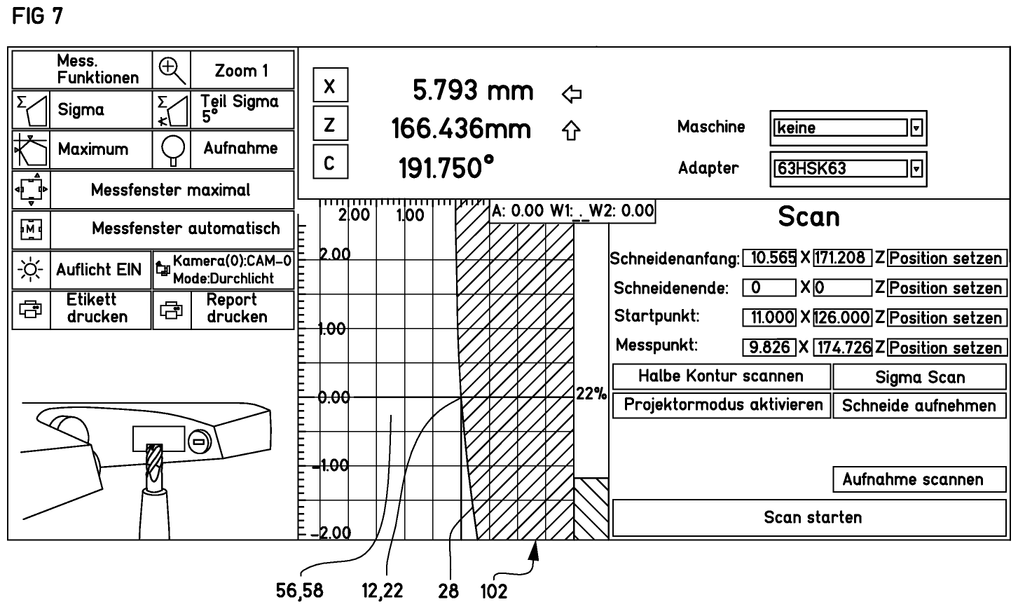

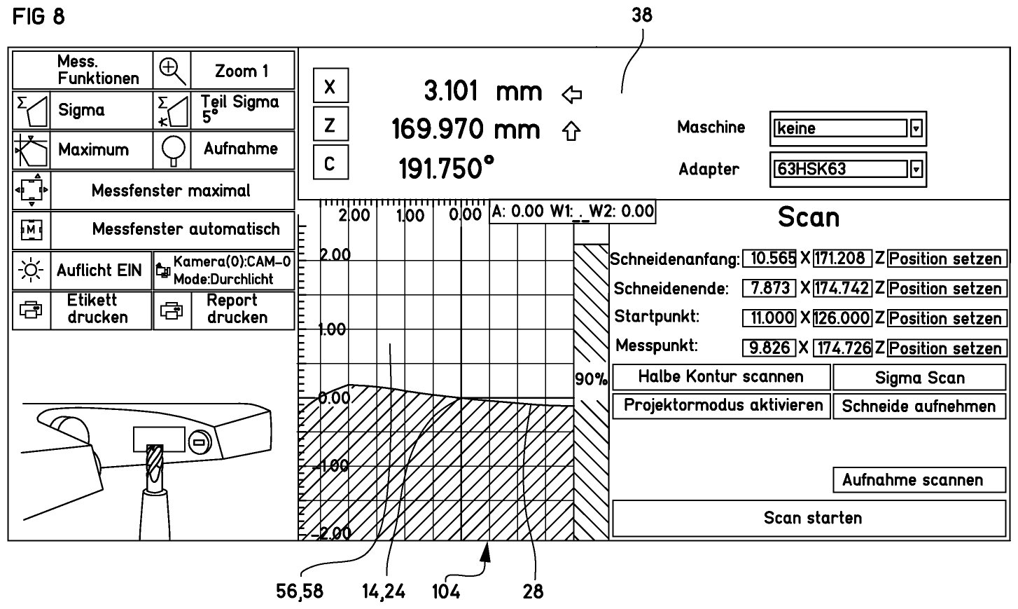

FIGS. 3 to 5 and FIGS. 6 to 8 respectively illustrate—for different types of tools 4—on the one hand a nonrotating tool 4 and on the other hand a rotating tool 4—the generation of the data for the collision-relevant digital twin 20, referred to in brief as the compilation of the collision-relevant digital twin 20 —through the use of which the simulated collision check is then carried out (cf. FIG. 9, Representation of a collision-relevant digital twin 20).

Compilation of a Collision-Relevant Digital Twin 20 for a Nonrotating Tool 4 (FIGS. 3 to 5):

During the generation of the collision-relevant digital twin 20 of a complete tool 6—in this case for a nonrotating tool 4, for example a turning tool 4—the latter is sampled 100—and a (two-dimensional) digital image 18 of the complete tool is thereby compiled.

The sampling 100 is carried out—in this case with a nonrotating tool 4—by a 2D scan—carried out by the camera apparatus 10—of the complete tool 6, a bilateral contour 28 of the complete tool 6 being measured—in a predetermined fixed position of the complete tool 6 (stationary spindle 42).

The camera apparatus 10 in this case approaches various heights of the complete tool 6 in an automated fashion and respectively carries out an acquisition of the complete tool 6 or a section 56 of the complete tool 6 at these heights, from which acquisitions the contour 28 or the contour profile 28 of the complete tool 6 is then “extracted” and then forms the (two-dimensional) digital image 18.

This is done by initially displacing the camera apparatus 10 stepwise from below, that is to say from the lower end of the complete tool 6, upward, that is to say toward the upper end of the complete tool 6, the camera apparatus 10 in this case being focused onto the contour 28 of one side of the complete tool 6—and the contour 28 of the one side of the complete tool 6 can in this case be determined.

The camera apparatus 10 is subsequently displaced stepwise from the top downward, the camera apparatus 10 in this case being focused onto the contour 28 of the other side of the complete tool 6—and the contour 28 of the other side of the complete tool 6 can in this case be determined.

In addition to the sampling 100 of the complete tool, a first cutting point 12, a cutting start point 12, and a second cutting point 14, a cutting end point 14, are then in turn measured 102, 104 for the tool 4 or the complete tool 6 by using the camera apparatus 10.

For this purpose, an operator 44 displaces the camera apparatus 10 to the two corresponding heights, which they can respectively control by using a display 58 on the monitor 38, and focuses the cutting start point 12 or cutting end point 14 there—and can then trigger the respective measuring 102, 104 by using the keyboard 40.

In the digital image 18, a cutting region 16 is then ascertained 106 by using the measured first and the measured second cutting point 12, 14 or by using these ascertained closest lying points 22, 24 in the digital image 18 (“collision-relevant digital twin” 20).

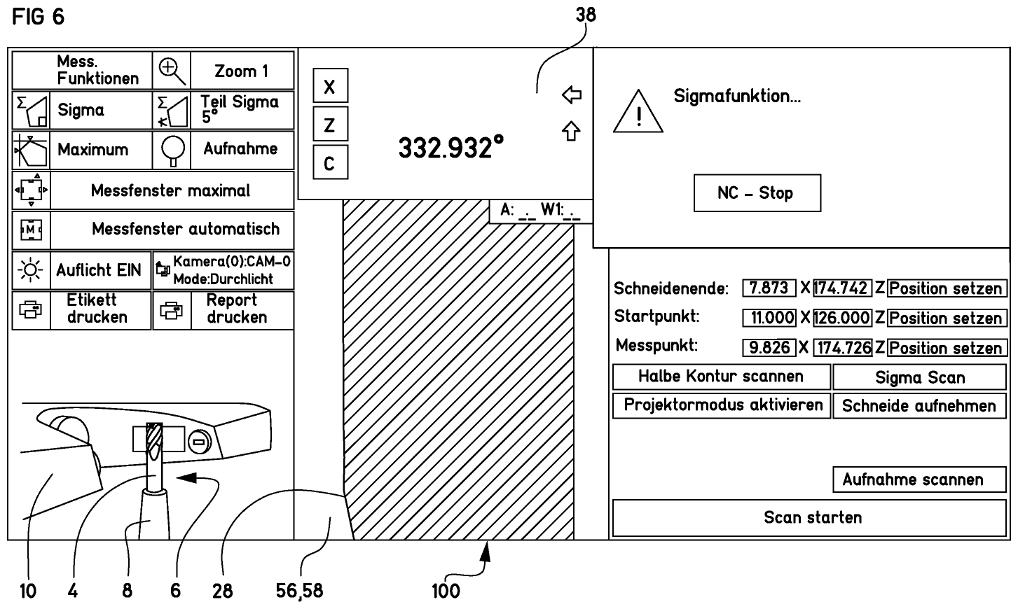

Compilation of a Collision-Relevant Digital Twin 20 for a Rotating Tool 4 (FIGS. 6 to 8):

During the generation of the collision-relevant digital twin 20 of a complete tool 6—in this case for a rotating tool 4, for example a milling tool 4—the latter is likewise sampled 100—and a (three-dimensional) digital image 18 of the complete tool 6—in this case of a rotating tool 4—is compiled.

The sampling 100 is carried out—in this case with a rotating tool 4—by a 3D scan—carried out by the camera apparatus 10—of the complete tool 6, a unilateral contour 28 of the complete tool being measured—with a differently rotated complete tool 6 (rotating spindle 42).

The camera apparatus 10 in this case approaches various heights of the complete tool 6 in an automated fashion—and respectively carries out acquisitions of the complete tool 6 or a section 56 of the complete tool 6 in complete tool positions rotated differently (by using the spindle 42) at these heights, from which acquisitions the envelope contour 30 of the complete tool 6 is then “extracted” and then forms the three-dimensional digital image 18.

This is done by displacing the camera apparatus 10 stepwise from below, that is to say from the lower end of the complete tool 6, upward, that is to say toward the upper end of the complete tool 6, the camera apparatus 10 in this case being focused onto the contour 28 of one side of the complete tool 6. At the approached heights, various acquisitions of the complete tool 6 are respectively made—in respectively differently rotated complete tool positions.

In addition to the sampling 100 of the complete tool 6, a first cutting point 12, a cutting start point 12, and a second cutting point 14, a cutting end point 14, are then in turn measured 102, 104 for the tool 6 or the complete tool 6 by using the camera apparatus 10.

For this purpose, an operator 44 displaces the camera apparatus 10 to the two corresponding heights, which they can respectively control by using a display 58 on the monitor 38, and focuses the cutting start point 12 or cutting end point 14 there—and can then trigger the respective measuring 102, 104 by using the keyboard 40.

In the digital image 18, a cutting region 16 is then ascertained 106 by using the measured first and the measured second cutting point 12, 14 or by using these ascertained closest lying points 22, 24 in the digital image 18 (“collision-relevant digital twin” 20).

Collision-Relevant Digital Twin 20 (FIG. 9):

FIG. 9 shows a collision-relevant digital twin 20 of a complete tool 6 —represented from step data generated by the presetting instrument 2 (cf. Section: “Compilation of a collision-relevant digital twin 20 for a rotating tool 4 (FIGS. 6 to 8)”).

FIG. 9 thus shows the digital image 18 (3D model) of a tool holder 8 with a clamped tool 4—in this case a similar one to the (hydraulic-expansion) chuck 8 with a clamped milling tool 4 of FIG. 1, in which the cutting region 16 according to the invention, of the tool, is determined 106 (and—for the sake of illustration—marked in color).

On the basis of these data, the machine tool 26 and/or an external programming station then carries out the collision simulation.

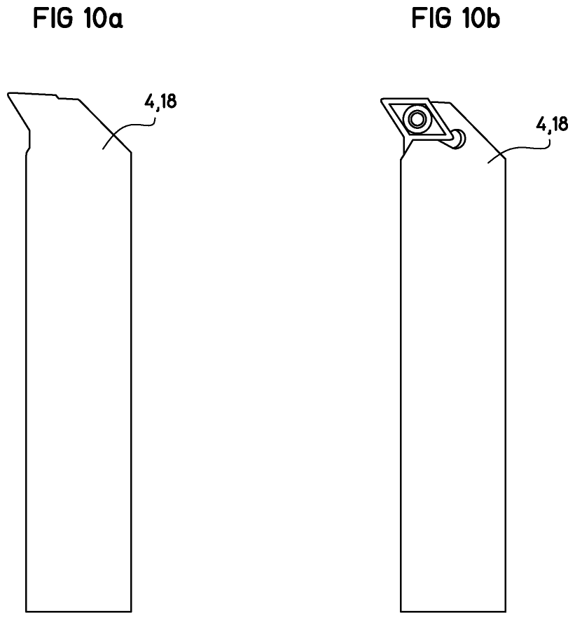

“Stitched” Image of a Tool 4 (FIGS. 10a and b):

FIGS. 10a and 10b respectively show an image 18 of a tool 4 stitched in the transmitted-light method and in the reflected-light method.

In this image, a cutting region 16 may then be ascertained by using at least the first cutting point 12 or the first and the second cutting point 12, 14—and the “collision-relevant” or “machining-relevant digital twin” 20 can thus be generated.

Although the invention has been illustrated and described in detail by the preferred exemplary embodiments, the invention is not restricted by the examples disclosed and other variations may be derived therefrom without departing from the protected scope of the invention.

The following is a summary list of reference numerals and the corresponding structure used in the above description of the invention:
2 apparatus for measuring a tool or a complete tool, presetting instrument
4 (rotating/nonrotating) tool, turning tool, milling tool
6 complete tool
8 tool holder, (hydraulic-expansion) chuck
10 measuring unit, (optical) metrology device, camera unit
12 first cutting point, cutting start point
14 second cutting point, cutting end point
16 cutting region
18 digital image
20 collision-relevant digital twin
22 a point lying closest to the first cutting point in the digital image
24 a point lying closest to the second cutting point in the digital image
26 machine tool, CNC machine tool, CNC processing machine
28 contour, contour profile
30 envelope contour
32 workpiece
34 calculation and control unit
36 interface to the machine tool
38 display device, monitor
40 input device, keyboard
42 spindle
44 operator
46 rotation axis
48 camera
50 illumination device
52 carriage
54 printer
56 section
58 display
100 sampling
102 measuring of the first cutting point, or of the cutting start point
104 measuring of the second cutting point, or of the cutting end point
106 ascertainment of a cutting region

1. An apparatus for measuring a tool or a complete tool including a tool holder and a tool clamped in the tool holder, the apparatus comprising:
a measuring unit and a calculation and control unit adapted:
to sample the tool or the complete tool for compilation of a digital image of the tool or of the complete tool;
to measure at least one first cutting point or a cutting start point, and a second cutting point or a cutting end point, for the tool or the complete tool, in addition to the sampling of the tool or of the complete tool; and
to ascertain a cutting region in the digital image by using at least the first cutting point or the first and second cutting points to form a collision-relevant digital twin.

2. The apparatus for measuring a tool or a complete tool including a tool holder and a tool clamped in the tool holder according to claim 1, wherein:
said measuring unit and said calculation and control unit are adapted to compile a machining-relevant twin by using the digital image or the collision-relevant digital twin, having at least one of further information items or original information items or a particular structure or processing, besides information items assigned to the collision-relevant twin.

3. A tool presetting instrument, comprising:
the apparatus for measuring a tool or a complete tool including a tool holder and a tool clamped in the tool holder, according to claim 1.

4. A processing center, comprising:
the apparatus for measuring a tool or a complete tool including a tool holder and a tool clamped in the tool holder according claim 1; and
a machine tool;
the apparatus being at least one of mounted with said machine tool on a common base or integrated into said machine tool.

5. A processing center, comprising:
the tool presetting instrument according to claim 3; and
a machine tool;
the apparatus for measuring a tool or a complete tool including a tool holder and a tool clamped in the tool holder being at least one of mounted with said machine tool on a common base or integrated into said machine tool.

6. A method for compiling a digital image of a tool or a complete tool including a tool holder and a tool clamped in the tool holder, the method comprising:
using an apparatus for measuring a tool or a complete tool to sample the tool or the complete tool for the compilation of the digital image;
in addition to the sampling of the tool or of the complete tool, measuring at least one first cutting point or a cutting start point, and a second cutting point or a cutting end point for the tool or the complete tool by using the apparatus for measuring a tool or a complete tool; and
ascertaining a cutting region in the digital image by using at least the first cutting point or the first and second cutting points to form a collision-relevant digital twin.

7. The method for compiling a digital image according to claim 6, which further comprises carrying out samplings of the tool or of the complete tool at different tool or complete tool heights, and ascertaining the digital image from the samplings.

8. The method for compiling a digital image according to claim 6, which further comprises:
during a determination of the cutting region by using at least the first cutting point or the first and second cutting points, determining a point lying closest or points lying closest to at least the first cutting point or the first and second cutting points in the digital image of the tool or complete tool; and
ascertaining the cutting region or marking the cutting region in the digital image by using the closest lying point or closest lying points.

9. The method for compiling a digital image according to claim 6, which further comprises, during the sampling, carrying out a 2D scan of the tool or of the complete tool by using the apparatus for measuring a tool or a complete tool, and measuring a bilateral contour of the tool or of the complete tool in a predetermined fixed position during the 2D scan.

10. The method for compiling a digital image according to claim 6, which further comprises, during the sampling, carrying out a 3D scan of the tool or of the complete tool by using the apparatus for measuring a tool or a complete tool, measuring a unilateral contour of the tool or of the complete tool during the 3D scan, rotating the tool or the complete tool during the measuring, and ascertaining an envelope contour.

11. The method for compiling a digital image according to claim 6, which further comprises providing the tool as a rotating tool, and during the sampling, carrying out a 3D scan of the rotating tool or of the complete tool.

12. The method for compiling a digital image according to claim 6, which further comprises, for the compilation of the digital image of the complete tool, only carrying out the sampling of the tool for the complete tool if and when data for the digital image of the tool holder are available in another way or have already been at least one of stored or read in.

13. The method for compiling a digital image according to claim 6, which further comprises, during the compilation of the digital image of the tool or of the complete tool, generating at least one data set or a plurality of data sets, or a data set having data of the digital image and having data for the ascertained cutting region or a data set having data of the digital image and having data for the ascertained cutting region as well as having measuring data of the tool or data from measuring, by using the apparatus for measuring a tool or a complete tool.

14. The method for compiling a digital image according to claim 6, which further comprises measuring the tool or the complete tool by using the apparatus for measuring a tool or a complete tool.

15. The method for compiling a digital image according to claim 6, which further comprises carrying out a collision check by using the digital image or the collision-relevant digital twin.

16. The method for compiling a digital image according to claim 6, which further comprises using the digital image or the collision-relevant digital twin to compile the machining-relevant twin having at least one of further information items or original information items in a particular structure or processing, in addition to information items assigned to the collision-relevant twin.

17. The method for compiling a digital image according to claim 6, which further comprises carrying out the method with at least one of a cutting tool or a cutting tool compressed in the tool holder.
